(19) United States
(12) Patent Application Publication
(10) Pub. No.: US 2022/0279895 A1
(43) Pub. Date: Sep. 8, 2022

(54) FOOTWEAR MIDSOLES WITH BAFFLES

(71) Applicant: HEWLETT-PACKARD DEVELOPMENT COMPANY, L.P., Spring, TX (US)

(72) Inventors: Stephan W EMMENEGGER, San Diego, CA (US); Edward PONOMAREV, San Diego, CA (US)

(21) Appl. No.: 17/628,369

(22) PCT Filed: Aug. 26, 2019
(86) PCT No.: PCT/US2019/048186

§ 371 Date: Jan. 19, 2022

(51) Int. Cl. A43B 13/18; B29D 35/06; B29D 35/10

(52) U.S. Cl. CPC A43B 13/188; B29D 35/061; B29D 35/10

(57) ABSTRACT

An example article includes a baffle to be inserted into a mold cavity of a mold for a midsole of an article of footwear. The baffle is to divide the mold cavity into a first sub-cavity and a second sub-cavity. The baffle is to isolate a first material injected into the first sub-cavity from a second material injected into the second sub-cavity. The second material has a differing material property to the first material.

### BACKGROUND

Footwear tends to be mass produced with variance among a specific style or type of footwear typically being limited to size. Mass production of footwear is facilitated by industrial processes, such as injection molding, that are effective in keeping costs down when many of the same item are made.

### BRIEF DESCRIPTION OF THE DRAWINGS

FIG. 1 is a perspective view of an example apparatus to injection mold a midsole of an article of footwear with a baffle inserted into a mold cavity to isolate materials of different properties injected into different sub-cavities of the mold.

FIG. 2A is a cross-sectional view of the example apparatus of FIG. 1 with a baffle inserted into a midsole mold cavity,

FIG. 2B is a cross-sectional view of the example apparatus of FIG. 1 with a first material injected past the baffle into a first sub-cavity.

FIG. 20 is a cross-sectional view of the example apparatus of FIG. 1 with an injection needle withdrawn from a first sub-cavity and into a second sub-cavity.

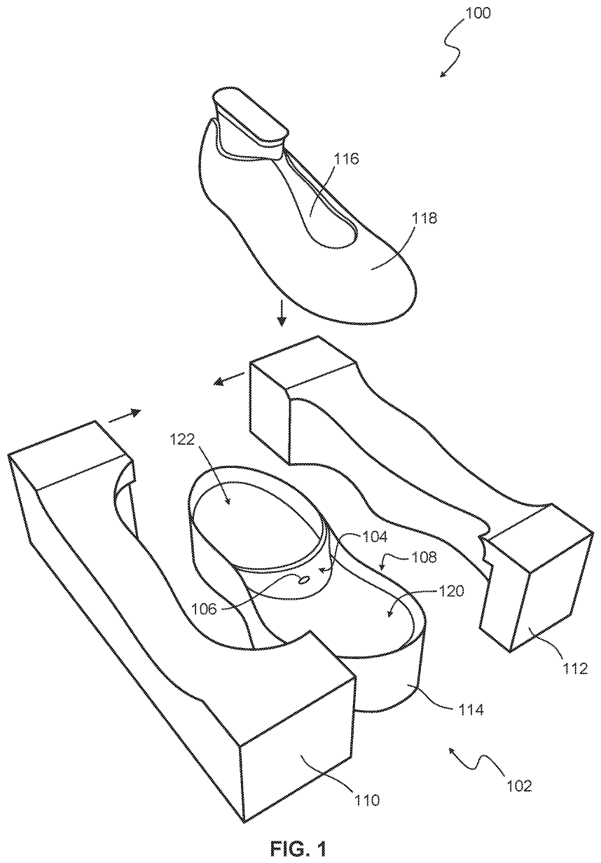

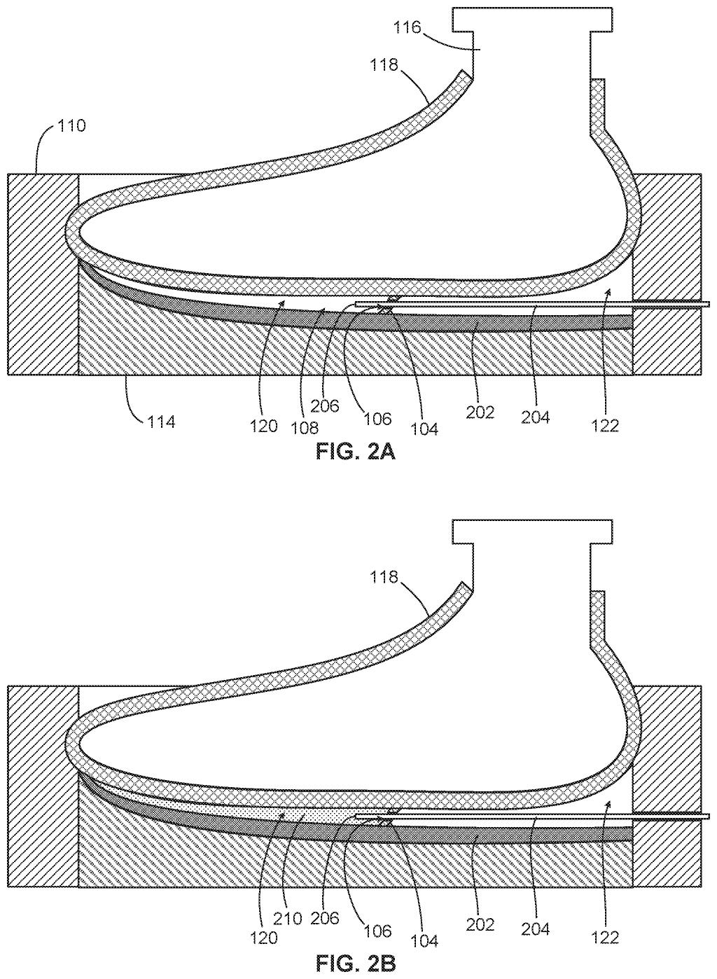

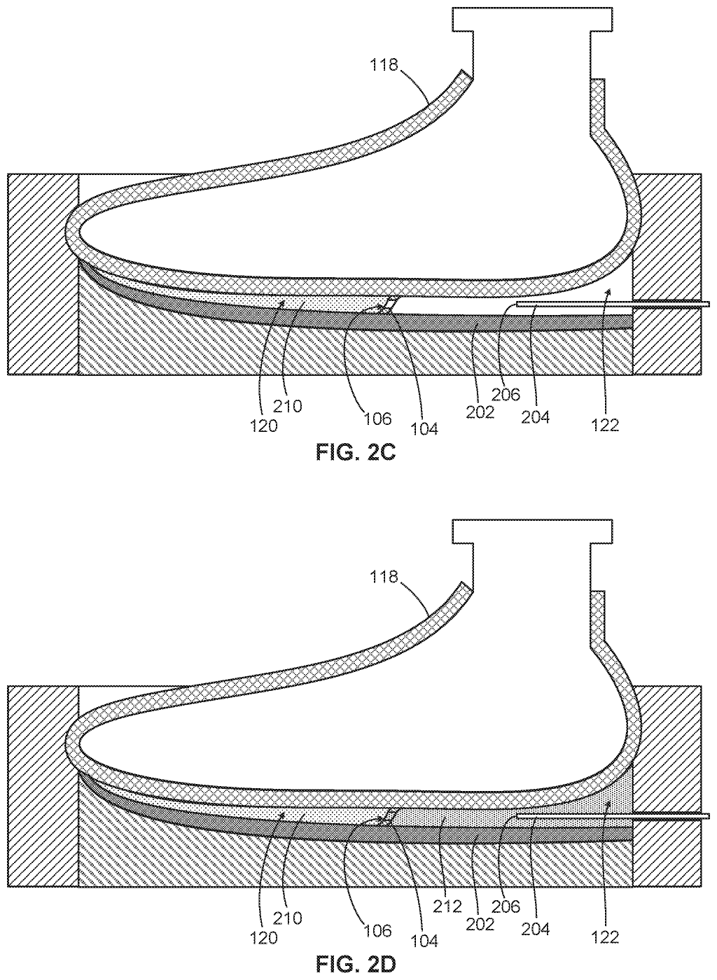

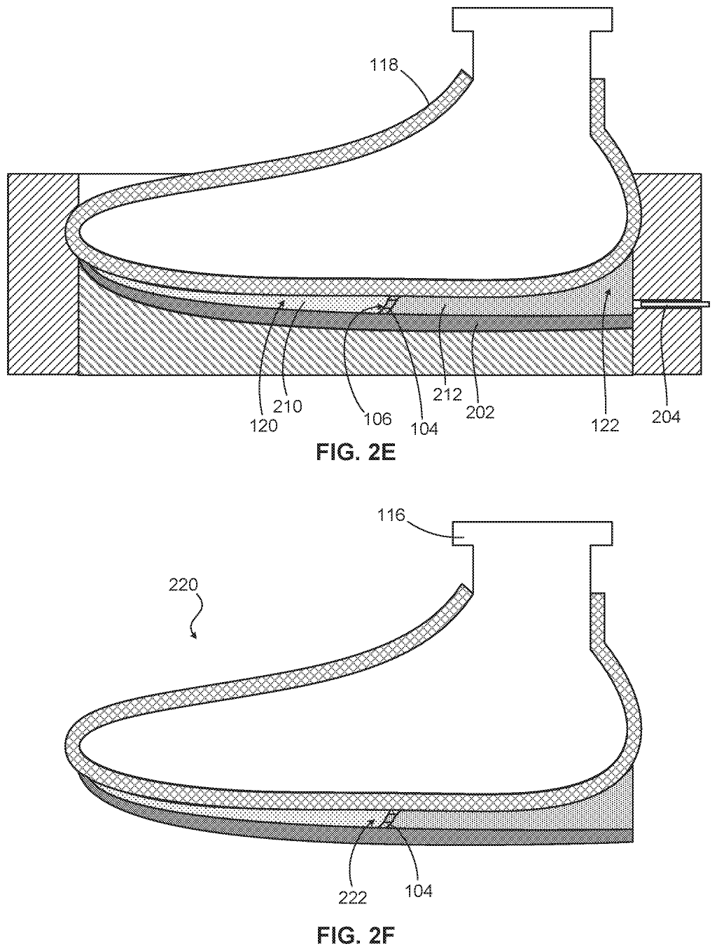

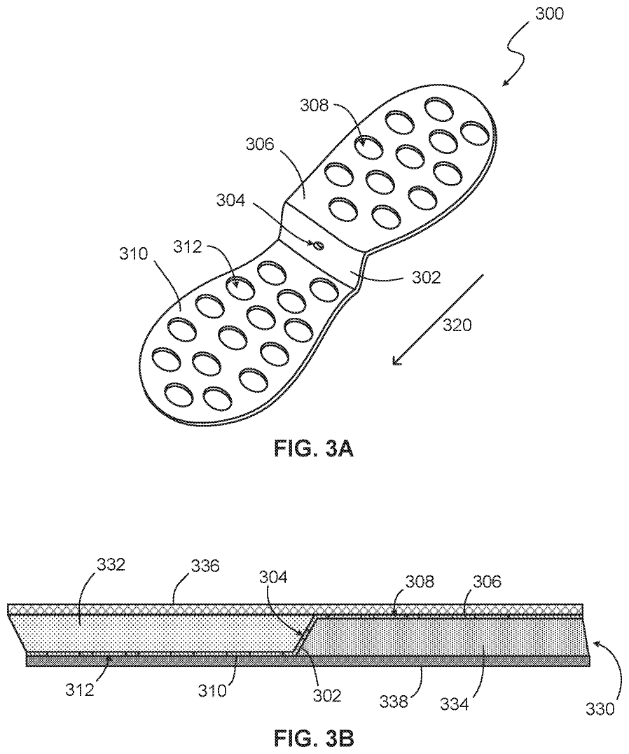

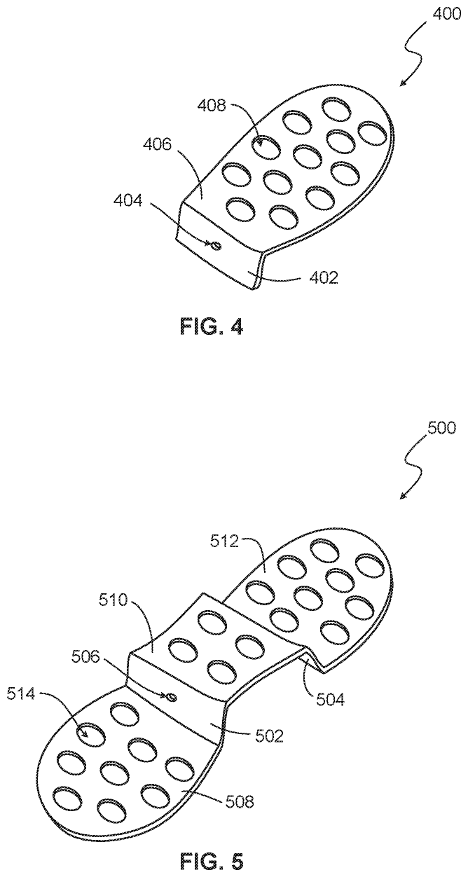

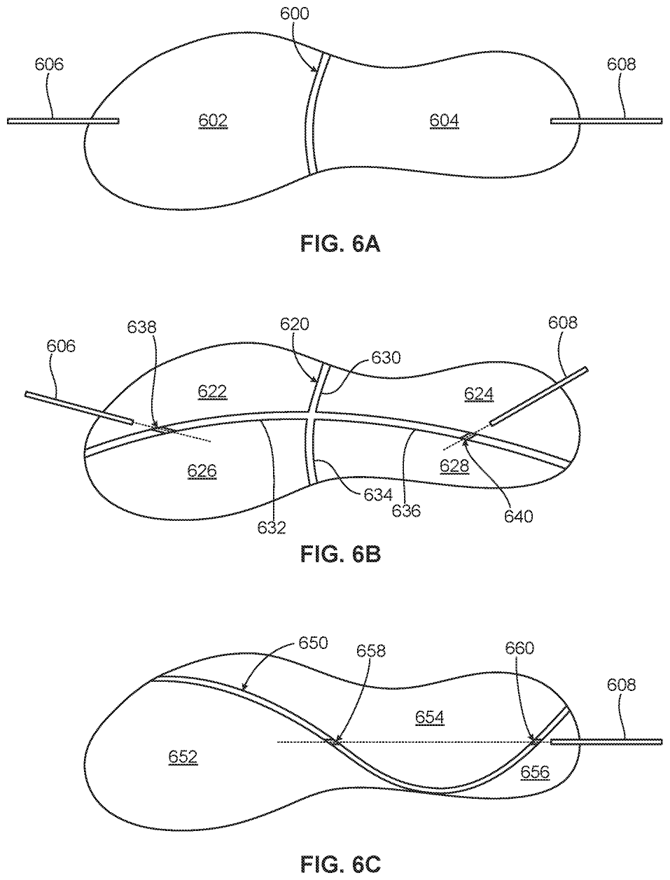

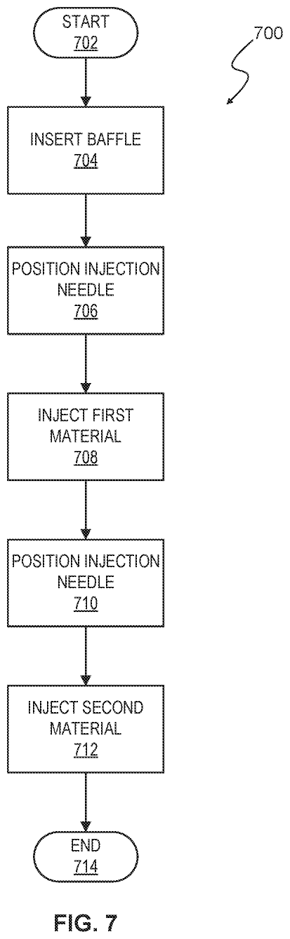

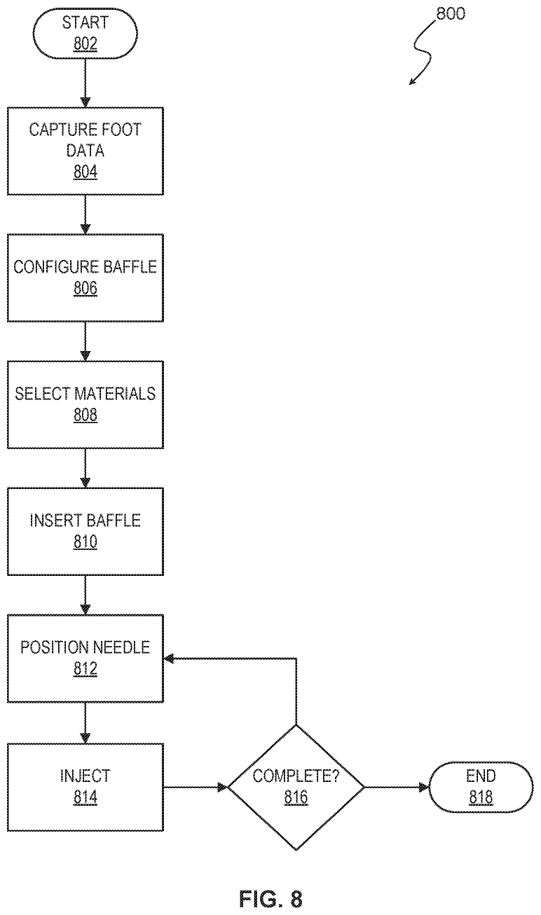

FIG. 2D is a cross-sectional view of the example apparatus of FIG. 1 with a second material injected into a second sub-cavity.

FIG. 2E is a cross-sectional view of the example apparatus of FIG. 1 with an injection needle withdrawn from a second sub-cavity.

FIG. 2F is a cross-sectional view of an article of footwear with injection molding midsole and integrated baffle removed from the example apparatus of FIG. 1.

FIG. 3A is a top perspective view of an example baffle with upper and lower stiffeners,

FIG. 3B is a side view of the example baffle of FIG. 3A in a midsole including first and second injected materials.

FIG. 4 is a top perspective view of an example baffle with an upper or lower stiffener.

FIG. 5 is a top perspective view of example baffles with stiffeners,

FIG. 6A is a plan view of an example baffle without an opening for an injection needle.

FIG. 6B is a plan view of an example baffle including legs to define more than two sub-cavities,

FIG. 6C is a plan view of an example baffle that defines more than two sub-cavities and includes a plurality of openings for an injection needle.

FIG. 7 is a flowchart of an example method of molding a midsole of an article of footwear with a baffle.

FIG. 8 is a flowchart of an example method of using a midsole baffle to mold a midsole of an article of footwear specific to a wearer.

### DETAILED DESCRIPTION

Footwear often lacks customizable features or features specific to an individual wearer or small group of wearers. The mass production technologies that keep costs low also tend to inhibit wearer-specific features.

A midsole may be injection molded with one shot of polyurethane (PU) foam or similar material. Such midsoles therefore tend to have homogenous material properties. If not homogenous, then the material properties are often unpredictable due to chaotic flow of injected material.

When molding an article of footwear, such as a shoe, a midsole may be customized by inserting a baffle into a midsole mold cavity to divide the cavity into sub-cavities. The sub-cavities may be injected with materials having different properties, which may be selected to provide an orthopedic function to the midsole. The baffle isolates the sub-cavities so that the different materials are precisely injected into the desired locations. The baffle remains in place and becomes part of the midsole. The material, thickness, and geometry of the baffle may be selected to provide further orthopedic function to the midsole. A stiffener may extend from the baffle, forwards or backwards along the length of the midsole or laterally, to provide further orthopedic function. The stiffener may include openings to promote bonding of injected material to the upper, outsole, or other part of the article of footwear.

The baffle allows for the orthopedic function provided by the different injected materials and the baffle itself to be customized for the specific individual wearer or a small group of wearers with similar orthopedic conditions.

FIG. 1 shows an example apparatus 100 to injection mold a midsole of an article of footwear, such as a shoe. The apparatus 100 may be used with an injection molding machine, such as a carousel-type machine that rotates a plurality of molds to different stations. The example apparatus 100 may be a mold or part of a mold of such an injection molding machine. The apparatus includes a mold frame 102.

The mold frame 102 defines a mold cavity 108. The mold frame 102 may include opposing side frames 110, 112 and a bottom frame 114. The mold frame 102 receives a last 116 that carries an upper 118 of an article of footwear that is under manufacture to enable the molding of a midsole onto the upper 118. The side frames 110, 112, bottom frame 114, and the last 116 may be movable with respect to each other to open and close the mold cavity 108. The opposing side frames 110, 112, bottom frame 114, and upper 118 as carried by the last 116 may be brought into mutual engagement to close the cavity 108. Material, such as polyurethane (PU), thermoplastic polyurethane (TPU), rubber, or the like, may be injected into the closed mold cavity 108 to form a midsole.

A baffle 104 is insertable into the mold cavity 108 to divide the mold cavity into a first sub-cavity 120 and a second sub-cavity 122. The baffle 104 isolates a first material injected into the first sub-cavity from a second material injected into the second sub-cavity. The second material has a differing material property to the first material. Examples of material properties include density, material composition (e.g., PU vs. TPU), color, and stiffness.

The baffle 104 may include a stiff piece of material that extends vertically in the mold cavity to act as a wall between the first sub-cavity 120 and the second sub-cavity 122. The baffle may be made of a suitable material such as plastic or metal. The baffle 104 may have a thin wall that is sufficiently strong and rigid to avoid significant deformation under pressure of injected material. While some deformation is tolerable, it should be understood that larger deformation may translate into less accuracy in the finished midsole.

The baffle 104 may include an injection opening 106 to receive an injection molding needle to inject a first material into the first sub-cavity 120. After injection of the first material into the first sub-cavity 120, the different second material may be injected into the second sub-cavity 122. The first and second materials bond to the upper 118 and outsole as well as to the baffle 104, which ultimately forms part of the finished article of footwear.

The baffle 104 allows a sequence of materials of different properties to be injected to make a customized midsole. A property, such as material composition, density, color, stiffness, and similar, may be varied at different locations of the midsole. This may be used to create a unique density profile, appearance, or similar feature for the article of footwear. Any number of material properties may be varied at any suitable location of a given midsole. The materials used may be selected to provide an orthopedic function to the midsole. For example, a stiffer material may be provided to the second sub-cavity 122 if the wearer has a heel strike gait, Conversely, a stiffer material ay be provided to the first sub-cavity 120 if the wearer has forefoot strike.

The baffle 104 may remain in the midsole after injection of the first and second materials to provide an orthopedic function to the midsole. As such, in addition to customizing the midsole by selection of the first and second injected materials, the characteristics of the baffle 104 may be selected as specific to the wearer or group of wearers. For example, the position, geometry, thickness, or material of the baffle 104 may be selected to provide a customized stiffness characteristic to the midsole.

FIGS. 2A to 2F show an example method of manufacture of a midsole of an article of footwear with a baffle 104, The method may be performed by the example apparatus 100 of FIG. 1 and is described in terms of the apparatus 100 for sake of convenience. Further detail of the apparatus 100 is shown. The method may be performed by other apparatuses.

FIG. 2A shows a mold frame that is closed around a lasted upper 118. An outsole 202 may be provided to a bottom frame 114, so that the outsole 202, lasted upper 118, and opposing side frames 110 enclose a midsole mold cavity 108.

The baffle 104 is inserted into the midsole mold cavity 108 to split the midsole mold cavity 108 into a first sub-cavity 120 and a second sub-cavity 122.

An injection needle 204 is inserted into the midsole mold cavity 108 and though an opening 106 in the baffle 104, so that a tip 206 of the injection needle 204 is positioned to inject material into the first sub-cavity 120. The injection needle 204 may be pushed through the opening 106, so that the tip 206 is inside the first sub-cavity 120. The opening 106 may be sized to tightly fit the injection needle 204, so that the baffle 104 seals against the injection needle 204 to prevent backflow of material from the first sub-cavity 120 to the second sub-cavity 122.

As shown in FIG. 2B, a first material 210 may be injected through the injection needle 204 and into the first midsole sub-cavity 120. The first material may adhere to the outsole 202, the upper 118, and surface of the baffle 104 facing the first sub-cavity 120. The baffle 104 stops the first material from filling the second sub-cavity 122. Further, the fit of the injection needle 204 in the opening 106 of the baffle 104 may prevent any first material from leaking into the second sub-cavity 122.

As shown in FIG. 2C, during or shortly after injection of the first material 210, the injection needle 204 is withdrawn from the first sub-cavity 120, so that the tip 206 of the injection needle 204 is located inside the second midsole sub-cavity 122. First material 210 may continue to be injected while the injection needle 204 is withdrawn and the tip 206 is still within the first sub-cavity 120, so that first material 210 fills the space previously occupied by the injection needle 204. In another example, the injection needle 204 is withdrawn from the mold completely and another injection needle specifically for the second material is inserted into the second sub-cavity 122.

Then, as shown in FIG. 2D, a second material 212 is injected through the injection needle 204 and into the second sub-cavity 122. The second material does not enter the first sub-cavity 120 due to the presence of the previously injected first material 210. The second material 212 may adhere to the outsole 202, the upper 118, and surface of the baffle 104 facing the first sub-cavity 120. The opening 106 in the baffle 104 may be filled by either or both materials 210, 212.

As shown in FIG. 2E, during or shortly after injection of the second material 212, the injection needle 204 is withdrawn from the second sub-cavity 122. Second material 212 may continue to be injected while the injection needle 204 is withdrawn and the tip 206 is still within the second sub-cavity 122, so that second material 212 fills the space previously occupied by the injection needle 204.

Then, as shown in FIG. 2F, the mold may be opened and the last 116 carrying the article of footwear 220 with its injection molded composite midsole 222 and integrated baffle 104 may be removed.

FIG. 3A shows an example baffle article 300. The baffle article 300 may be used with the apparatus 100 in place of the baffle 104. The baffle article 300 is insertable into a midsole mold cavity to divide the cavity into two sub-cavities.

The baffle article 300 includes a baffle 302 that extends vertically to isolate the sub-cavities from one another. The baffle 302 includes an opening 304 to receive an injection needle.

The baffle article 300 further includes an upper stiffener 306 extending from the baffle 302 to contact an upper of the article of footwear. The upper stiffener 306 remains with the baffle 302 in the midsole after injection of the midsole materials.

The upper stiffener 306 may provide an orthopedic function to the midsole. For example, the material, thickness, and geometry of the upper stiffener 306 may be selected based on a wearer's orthopedic needs.

The upper stiffener 306 may include bonding openings 308 to allow bonding of injected midsole material to the upper of the article of footwear. That is, material injected in the vicinity of the upper stiffener 306 may flow through the bonding openings 308 to contact the upper, so that the midsole and upper are bonded together in the vicinity of the upper stiffener 306.

The upper stiffener 306 may be shaped and sized to extend the full width and length sub-cavity. In other examples, the upper stiffener 306 is smaller than the sub-cavity.

The baffle article 300 further includes a lower stiffener 310 extending from the baffle 302 to contact an outsole of the article of footwear. The lower stiffener 310 remains with the baffle 302 in the midsole after injection of the midsole materials.

The lower stiffener 310 may provide an orthopedic function to the midsole. For example, the material, thickness, and geometry of the lower stiffener 310 may be selected based on a wearer's orthopedic needs.

The lower stiffener 310 may include bonding openings 312 to allow bonding of injected midsole material to the outsole of the article of footwear. Material injected in the vicinity of the lower stiffener 310 may flow through the bonding openings 312 to contact the outsole, so that the midsole and outsole are bonded together in the vicinity of the lower stiffener 310.

The lower stiffener 310 may be shaped and sized to extend the full width and length sub-cavity. In other examples, the lower stiffener 310 is smaller than the sub-cavity.

In some examples, the toe of the article of footwear points in a direction 320. Hence, the lower stiffener 310 is at the forefoot and the upper stiffener 306 is at the heel. In other examples, the toe of the article of footwear points opposite the direction 320, with the lower stiffener 310 being at the heel and the upper stiffener 306 being at the toe. The relative orientation of the stiffeners 306, 310 may be selected based on the orthopedic function provided.

FIG. 3B shows the example baffle article 300 in cross-section within a midsole 330 that includes injected first and second midsole materials 332, 334 that have a different property, such as density, composition, color, or stiffness. As can be seen, first midsole material 332 bonds directly to an upper 336 and bonds to an outsole 338 via bonding openings 312 in the lower stiffener 310. Similarly, second midsole material 334 bonds directly to the outsole 338 and bonds to the upper 336 via bonding openings 308 in the upper stiffener 306. The baffle 302 isolates the first and second midsole materials 332, 334. The baffle 302, lower stiffener 310, and upper stiffener 306 bond with the first and second midsole materials 332, 334 to become an integral part of the midsole 330.

FIG. 4 shows an example baffle article 400. The baffle article 400 may be used with the apparatus 100 in place of the baffle 104. The baffle article 400 is insertable into a midsole mold cavity to divide the cavity into two sub-cavities.

The baffle article 400 includes a baffle 402 that extends vertically to isolate the sub-cavities from one another. The baffle 402 includes an opening 404 to receive an injection needle.

The baffle article 400 further includes a stiffener 406 extending from the baffle 402, The stiffener 406 may be designed to contact the upper or outsole of the toe region or heel region of the article of footwear. The stiffener 406 may provide an orthopedic function to the selected location of the midsole. Further, the stiffener 406 may include bonding openings 408 to allow bonding of injected midsole material to the upper or outsole of the article of footwear.

FIG. 5 shows an example baffle article 500. The baffle article 500 may be used with the apparatus 100 in place of the baffle 104. The baffle article 500 is insertable into a midsole mold cavity to divide the cavity into a plurality of sub-cavities.

The baffle article 500 includes a plurality of baffles 502, 504. Each baffle 502, 504 extends vertically to isolate adjacent sub-cavities from one another. Each baffle 502, 504 includes an opening 506 to receive an injection needle.

The baffle article 500 further includes stiffeners 508, 510, 512. An end stiffener 508, 512 extends from a respective baffle 502, 504, A central stiffener 510 extends between the baffles 502, 504. Depending on the orientation of the baffle article 500 in the midsole, a stiffener 508, 510, 512 may contact the upper or outsole of the toe region, arch region, or heel region of the article of footwear. A stiffener 508, 510, 512 may provide an orthopedic function to its location in the midsole. Further, a stiffener 508, 510, 512 may include bonding openings 514 to allow bonding of injected midsole material to the upper or outsole of the article of footwear.

In other examples, any number of baffles and stiffeners may be provided. A baffle may isolate sub-cavities along a length of a midsole to provide a midsole orthopedic profile along the length of the article of footwear. A baffle may isolate sub-cavities along a width of a midsole to provide a midsole orthopedic profile along the width of the article of footwear.

FIGS. 6A to 6C show plan views of various midsole cavities divided into sub-cavities by example baffles.

FIG. 6A shows an example baffle 600. The baffle 600 may be used with the apparatus 100 in place of the baffle 104. The baffle 600 is insertable into a midsole mold cavity to divide the cavity into toe and heel sub-cavities 602, 604. The baffle 600 is similar to the baffle 104, except an opening to accommodate an injection needle is omitted. As such, the sub-cavities 602, 604 may be provided with different materials via different injection needles 606, 608 from different directions.

FIG. 6B shows an example baffle 620. The baffle 620 may be used with the apparatus 100 in place of the baffle 104. The baffle 620 is insertable into a midsole mold cavity to divide the cavity into a plurality of sub-cavities 622-628. In this example, four sub-cavities are provided, though more or fewer are possible. The baffle 620 includes legs 630-636 that isolate respective sub-cavities 622-628. The legs 630-636 may be positioned to define the sub-cavities 622-628 to obtain any suitable midsole material distribution. Any leg 630-636 may include an opening 638, 640 to receive an injection needle 606, 608 to allow material to be injected into a sub-cavity on a far side of the leg 630-636.

FIG. 6C shows an example baffle 650. The baffle 650 may be used with the apparatus 100 in place of the baffle 104. The baffle 650 is insertable into a midsole mold cavity to divide the cavity into a plurality of sub-cavities 652-656. In this example, three sub-cavities are provided, though more or fewer are possible. The baffle 650 follows path that has reversing curvature. A plurality of openings 658, 660 may be provided in the baffle 650 to allow injection of midsole material into the plurality of sub-cavities 652-656 using the same injection needle 608. For example, the injection needle 608 may extend through the openings 658, 660 to inject material into the sub-cavity 652. Then, the injection needle 608 may be withdrawn from the opening 658 but remain extending though the opening 660 to inject different material into the sub-cavity 654. Finally, the injection needle 608 may be withdrawn from the opening 660 to inject different material into the sub-cavity 656.

FIG. 7 shows an example method 700 of manufacture of a midsole of an article of footwear using a baffle placed inside a midsole mold cavity. The method 700 may be performed by the example apparatus 100 of FIG. 1. The method may be performed by other apparatuses. FIGS. 2A-2F may be referenced for example structure. The method begins at block 702.

At block 704, a baffle is inserted into a midsole mold cavity to separate the cavity into a plurality of sub-cavities. The baffle may include a stiffener. The baffle may be positioned in the cavity by a robot or human operator. An upper of the article of footwear may be provided to the mold cavity on, for example, a last. The mold cavity may then be closed.

At block 706, an injection needle is positioned to inject first material into a first midsole sub-cavity defined by the baffle. The injection needle may be pushed through an opening in the baffle.

At block 708, a first material is injected into the first sub-cavity to fill the first sub-cavity with first material. The first material may be selected to have a specific property, such as material composition, density, color, stiffness, or similar, that may be tailored to the specific article of footwear or the intended wearer.

At block 710, the same or a different injection needle is positioned to inject second material into a second midsole sub-cavity defined by the baffle. The injection needle may be retracted from the opening in the baffle, inserted through a different opening in the baffle, or inserted into the cavity from a different direction.

At block 712, a second material is injected into the second sub-cavity to fill the second sub-cavity with second material. The second material may be selected to have a specific property different from the first material, such as material composition, density, color, stiffness, or similar, that may be tailored to the specific article of footwear or the intended wearer.

The method 700 ends at block 714 with the formation of a midsole having an arrangement of materials of different properties and an integral baffle.

FIG. 8 shows an example method 800 of manufacture of a midsole of an article of footwear using a baffle that is integrated into the midsole. The method 800 may be performed by the example apparatus 100 of FIG. 1. The method may be performed by other apparatuses. FIGS. 2A-2F may be referenced for example structure. The method begins at block 802.

At block 804, data of a wearer's foot is captured. This may be done by a three-dimensional (3D) scan or other measurement technique to capture the shape of the foot, pressure plate analysis, gait analysis, or similar biometric measurement techniques. Such captured data may be used to determine the structure and composition of the midsole to be manufactured.

At block 806, a baffle is configured based on the data captured for the wearer's foot. An orthopedic analysis of an individual user of the footwear may be performed to select or configure the baffle. The shape, size, geometry, and material of the baffle, as well as any stiffeners provided to the baffle, may be selected as specific to the wearer. The number of zones of midsole material variance, may be selected as specific to the wearer. A baffle may be selected from a library of stock baffles. A baffle may be created on-demand, such as by 3D printing.

At block 808, a plurality of different midsole materials is selected. The materials may be selected for properties such as material composition, density, color, stiffness, and so on. The materials may be selected in conjunction with the baffle and any stiffeners provided to meet the orthopedic needs of the wearer. Hence, the midsole of the footwear may be customized to the wearer.

At block 810, the baffle is placed in a midsole mold cavity and then, at block 812, an injection needle is positioned to inject material into a sub-cavity defined by the baffle.

Material is injected into the sub-cavity, at block 814.

The same or different injection needle is positioned at another sub-cavity and the next selected material is injected, until the midsole is complete, at block 816.

The method ends at block 818 with the formation of a midsole having a customized arrangement of differing materials and an integrated baffle.

In view of the above, it should be apparent that the techniques described herein provide for readily customizable midsoles specific to a single wearer or group of wearers. Baffles may be used to define midsole sub-cavities for injection of materials of different properties to provide an orthopedic function. A baffle may include a stiffener to enhance the orthopedic function of the midsole.

It should be recognized that features and aspects of the various examples provided above can be combined into further examples that also fall within the scope of the present disclosure. In addition, the figures are not to scale and may have size and shape exaggerated for illustrative purposes.

1. An article comprising:
a baffle to be inserted into a mold cavity of a mold for a midsole of an article of footwear, the baffle to divide the mold cavity into a first sub-cavity and a second sub-cavity; and
wherein the baffle is to isolate a first material injected into the first sub-cavity from a second material injected into the second sub-cavity, wherein the second material has a differing material property to the first material.

2. The article of claim 1, further comprising an injection opening in the baffle to receive an injection molding needle to inject the first material into the first sub-cavity.

3. The article of claim 2, wherein the injection opening of the baffle is further to seal against the injection molding needle to prevent backflow of the first material into the second sub-cavity.

4. The article of claim 1, wherein the baffle is to remain in the midsole after injection of the first and second materials to provide an orthopedic function to the midsole.

5. The article of claim 4, wherein geometry of the baffle is selected based on an orthopedic analysis of an individual user of the footwear.

6. The article of claim 1, further comprising an upper stiffener extending from the baffle to contact an upper of the article of footwear, wherein the upper stiffener comprises bonding openings to allow bonding of the first or second material to the upper.

7. The article of claim 6, wherein the upper stiffener is to remain in the midsole after injection of the first and second materials to provide an orthopedic function to the midsole.

8. The article of claim 1, further comprising a lower stiffener extending from the baffle to contact an outsole of the article of footwear, wherein the lower stiffener comprises bonding openings to allow bonding of the first or second material to the outsole.

9. The article of claim 8, wherein the lower stiffener is to remain in the midsole after injection of the first and second materials to provide an orthopedic function to the midsole.

10. An article of footwear comprising:
a midsole including:
a first material that has a first material property;
a second material that has a second material property different to the first material property; and
a baffle that isolates the first material from the second material.

11. The article of claim 10, wherein the first material and second material have different densities.

12. The article of claim 10; wherein the first material, second material, and baffle provide an orthopedic function to the midsole.

13. The article of claim 10, further comprising a stiffener extending from the baffle to contact an outsole or upper of the article of footwear, wherein the stiffener comprises bonding openings to allow bonding of the first or second material to the outsole or upper.

14. A method comprising:
inserting a baffle into a midsole mold cavity, the baffle defining isolated first and second sub-cavities within the midsole mold cavity;
positioning an injection needle at the first sub-cavity;
injecting a first material into the first sub-cavity;
positioning the injection needle or a different injection needle at the second sub-cavity; and
injecting a second material into the second sub-cavity, wherein the second material is different from the first material.

15. The method of claim 14, further comprising inserting the injection needle through an opening in the baffle to position a tip of the injection needle within the first sub-cavity.
